(19) United States
(12) Patent Application Publication
(10) Pub. No.: US 2025/0057087 A1
(43) Pub. Date: Feb. 20, 2025

(54) METHOD TO ENHANCE SUBSTANCES UPTAKE BY PLANTS USING SELECTIVE ABLATION OF LIGHT PULSES TO REMOVE THE WAX CUTICLE

(71) Applicants: Luis Vidal Ponce Cabrera, Olive Branch, MS (US); Teresa Flores Reyes, Olive Branch, MS (US); Alejandro Ponce Flores, Olive Branch, MS (US)

(72) Inventors: Luis Vidal Ponce Cabrera, Olive Branch, MS (US); Teresa Flores Reyes, Olive Branch, MS (US); Alejandro Ponce Flores, Olive Branch, MS (US)

(21) Appl. No.: 18/450,483

(22) Filed: Aug. 16, 2023

(51) Int. Cl. A01G 7/04

(52) U.S. Cl. CPC A01G 7/045; A01N 25/00

(57) ABSTRACT

Disclosed in the present is materials and methods for delivering substances to plants. The invention describes a method to enhance substances uptake by plants using selective ablation of light pulses to remove the wax cuticle on a large scale in fields, comprising steps of light selective ablation of wax based optical properties of leaves, using lasers, pulsed lamps or other light sources like solar filtered solar light to remove the wax selectively without damage the leaves. Also disclosed is material for enhancing substances uptake by plants using selective ablation of light pulses to remove the wax cuticle, comprising selective ablation of light pulses of a wavelength of about 532 nm or within the range 495 to 570 nm.

### TECHNICAL FIELD

The present invention generally, relates to materials and methods for delivering substances to plants and in particular method to enhance substances uptake by plants using selective ablation of light pulses to remove the wax cuticle on a large scale in fields.

### BACKGROUND

Application and absorption of agrichemicals (e.g., foliar nutrients and pesticides) remains difficult in the agricultural field. Aerial sprays are preferred as a means to deliver agrochemicals over large areas, given that leaves are the most readily accessible tissues and represent a significant proportion of the total plant body.

Although the primary functions of wax layer are to prevent water loss and to act as a defence from pathogens and pests, the wax also make foliar applications of agrichemicals difficult. The movement of substances across the cuticle and into leaves is most feasible through the stomatal openings. But the collective area of stomatal openings is reduced.

Some attempts at delivering substances in plant have been disclosed in prior art patents in this field:

The U.S. patent number US20200037607A1 upon which the present invention relates to discloses materials and methods for delivering a substance to a plant. The prior art is directed to materials and methods for delivering substances to plants using light energy but has since been abandoned. However, the present invention adds novel features to this prior art.

The U.S. patent application publication number US20190116741A1 of 2014 Apr. 7 describes systems and methods for using light energy to facilitate penetration of substances in plants. Systems and methods are disclosed for delivering a substance into a plant. The systems and methods include a light energy that is applied to a first area on the plant to create a first indentation. The first indentation can be a minor incision or a rupture of a portion of the first area. Once the first indentation is created, a first dosage of the substance is applied to the first area in an amount effective to promote a biological response of the plant. It is contemplated that at least a portion of the substance is absorbed by the plant via the first indentation. However, this prior art does not use selective ablation of light pulses to remove the wax cuticle as taught in the present invention.

The US patent application publication number US11191278B2 that was filed on 2016 Mar. 25 discloses systems and methods for delivering nucleic acids to a plant. It discloses a method of delivering at least one nucleic acid to a plant, comprising: applying a light energy to a surface of the plant to create a pore; and applying at least one nucleic acid to the pore, wherein the at least one nucleic acid comprises RNA, wherein the at least one nucleic acid comprises at least one of a RNA interference (RNAi), an antisense RNA (asRNA), a micro RNA (miRNA), a small interfering RNA (siRNA), a double-stranded RNA (dsRNA), a non-coding RNA (ncRNA), mitochondrial RNA (mtDNA), and combinations thereof. However, this prior art employs methods for delivering nucleic acids to a plant and does not employ a method to enhance substances uptake by plants use selective ablation of light pulses to remove the wax cuticle as taught in the present invention.

Given that most features of this prior art are not the same as those being proposed in the present invention. None of the above cited prior art documents teach the same subject matter being taught in the present invention, there is need to develop and avail a more efficient way of delivering substances to plants.

It is therefore an object of this invention to improve the uptake of agrochemicals by plants.

The foregoing and other objects and advantages of the invention will appear as the description proceeds, reference being made from time to time to the accompanying drawing, forming part of the within disclosure.

### SUMMARY OF THE INVENTION

In summary, the present invention describes materials and methods for delivering substances to plants. The invention discloses a method to enhance substances uptake by plants using selective ablation of light pulses to remove the wax cuticle on a large scale in fields.

The invention provides a method designed to improve the capture of agrochemicals through the leaves of plants, which works by removing the wax cuticle to allow access of the substances.

This invention works based on the selectivity of the action of monochromatic pulses, whose wavelength is in the green colour range. Due to its wavelength, the pulsed light is absorbed only by the wax cuticle and instead it is reflected by the epidermis without affecting it. Once the wax cuticle has been removed, the chemical substance can be applied, which will easily penetrate the interior of the plant.

Referring now to the present invention, a method to enhance substances uptake by plants using selective ablation of light pulses to remove the wax cuticle, comprising steps of: using selective ablation of light pulses; removing the wax cuticle, and using lasers is provided. The method further comprise laser selective ablation of wax based on optical properties of leaves. The method further comprises selectively removing the wax and facilitating the entry of any agrochemical. The method further comprises the use of lasers, pulsed lamps or other light sources like solar filtered solar light to remove the wax selectively without damage the leaves.

The method of the present invention provides that the selective ablation of light pulses is being used to enhance substances uptake by plants. It will be understood that removing the wax cuticle is performed by using selective ablation of light pulses on a large scale in fields. In a preferred embodiment the lasers, pulsed lamps or other light sources like solar filtered solar light are used for selective ablation of wax based optical properties of leaves to remove the wax selectively without damage the leaves.

In a preferred embodiment, the method further steps of enhancing substances uptake by plants using selective ablation of light pulses to remove the wax cuticle on a large scale in fields; improving the capture of agrochemicals through the leaves of plants by removing the wax cuticle to allow access of the substances; selective ablation by laser using wavelength. In a preferred method, the selective ablation by laser using wavelength is based on the selectivity of the action of monochromatic pulses, whose wavelength is in the green colour range, wherein due to its wavelength, the pulsed light is absorbed only by the wax cuticle and instead it is reflected by the epidermis without affecting it. In the method once the wax cuticle has been removed, the chemical substance is applied, which can easily penetrate the interior of the plant.

In a preferred embodiment, the preferred plant is fresh citrus leaves due to their high reflection rate, low absorption rate, high absorption rate of the wax cuticle, good selectivity of the wax cuticle enabling them to be suitable for selectively ablated, and having the capacity to preserve the epidermis without damages. The method according to Claim 12, wherein the step of selective ablation is done by a laser using wavelength in the green range of spectrum 495 nm to 570 nm. In a preferred embodiment, the absorption spectrum of leaf extract further comprises: a wavelength ranges of between 350 and 700 nm, and an absorption coefficient of 0.02 and 0.2 m−1. Preferably, the laser selectivity further comprises a minimal damage to cuticle and leaf structure and high removal of wax rate and further comprising for the second harmonic of Nd laser of wavelength 532 nm however, the second harmonic of Nd laser can be of any wavelength in the range 495-570 nm.

In a preferred embodiment, a method for delivering substances to plants, comprising steps of: applying a laser ablation using green wavelength of 532 nm to penetrate epicuticular wax to the epidermal layer; applying laser ablation to enable a therapeutic compound application and penetration through cuticle-exfoliated areas, and successfully enabling the therapeutic compound to reach the epidermal layer. Additionally, it will be seen that in this embodiment the method has: the immediate effect of laser is to impact the leaf surface and generate accessibility for therapeutic compounds through wax cuticle selective ablation; at the step of impacting the leaf surface the area where the laser removed the wax also expose the epidermis; within the treated area, the laser is enabled to remove the wax without affecting the epidermis; the said treated area can be large ranging from mm to cm in diameter with a single laser shot; there is no perforation or thermal damage to the leaf, and further comprising a laser wavelength of about 532 nm, pulse duration of about 1 fs to 100 ns, and repetition rate of about 1-100,000 Hz, and material for enhancing substances uptake by plants using selective ablation of light pulses to remove the wax cuticle, comprising selective ablation of light pulses of a wavelength of about 532 nm or within the range 495 to 570 nm.

The are designed for: delivering substances to plants; removing the wax cuticle on a large scale in fields; improving the capture of agrochemicals through the leaves of plants, which works by removing the wax cuticle to allow access of the substances. The material for selective ablation of light pulses using laser pulses of 532 nm wavelength or within the range 495 to 570 nm for selective wax removal, wherein the laser further comprises short duration process (nanosecond range) minimizing thermal impact; does not need to be focused with a lens; is easy to implement for field conditions, and is compact, portable laser and of low cost.

These and other features, and advantages of the present invention will become apparent from the following detailed description, the accompanying drawings, and the appended claims.

### BRIEF DESCRIPTION OF FIGURES

FIG. 1A represents how micro-perforations prior art patent works as described in the present invention.

FIG. 1B is an enlarged view of the micro-perforations.

FIG. 1C is an enlarged view of elements of the micro-perforations.

FIG. 1D is an enlarged view of the elements shown in FIG. 1C.

FIG. 2 is a diagrammatic illustration of Citrus leaves.

FIG. 3 is a graph of selective ablation by laser using wavelength in the green range of spectrum.

FIG. 4 is cross section of a leaf prior to laser ablation.

FIG. 5 is a diagrammatic representation of a laser using green wavelength as described in the present invention.

FIG. 6 is a diagrammatic representation of a therapeutic compound application and penetration through cuticle-exfoliated areas, successfully reaching the epidermal layer.

FIG. 7 is an area where the laser removed the wax and expose the epidermis, with an enlarged portion showing the area.

These and other features, and advantages of the present invention will become apparent from the following detailed description, the accompanying drawings, and the appended claims.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another.

Plant cuticle is the outermost layer of plants, which covers leaves, fruits, flowers, and non-woody stems of higher plants. It protects plants against drought, extreme temperatures, UV radiation, chemical attack, mechanical injuries, and pathogen/pest infection. The cuticle is well known for its functions as a diffusion barrier limiting water and solute transport across the apoplast and for its protection of the plant against chemical and mechanical damage, as well as pest and pathogen attack (Riederer, 2006).

Generally, the prior art inventions provide a method of delivering a substance to a plant, the method comprising (a) exfoliating a region of epicuticular wax on a plant surface. The laser energy is applied using an erbium-doped yttrium aluminum garnet (Er: YAG) laser. The method is good, does not damage the leave. The main inconvenient is the high price of laser. In addition, the laser process implies an increase in temperature that can damage the epidermis.

The invention attempts to address the problem of foliar uptake of agrochemicals. It describes bow a laser selective wax removal can be done to enhance the substances uptake by plants. Aerial sprays are preferred as a means to deliver agrochemicals over large areas, given that leaves are the most readily accessible tissues and represent a significant proportion of the total plant body. Although the primary functions of wax layer are to prevent water loss and to act as a defense from pathogens and pests, the wax also make foliar applications of agrichemicals difficult. The movement of substances across the cuticle and into leaves is most feasible through the stomatal openings. But the collective area of stomatal openings is reduced.

Now according to the invention, the idea or subject matter teaches of an improvement of the substances uptake by selective laser ablation. The invention is based on selectivity, wherein the process is based on the high reflectivity of leaves for green light. The invention is designed to using a green laser beam the wax that can be removed selectively, without damaging any other part of the leaf.

There are two patents related to this invention. One issued patent and other is an abandoned application. However, they both use different approached and mechanism to improve the substance uptake by the plant

The subject matter of the present invention is new and exceeds the previous prior art disclosures in many aspects.

The U.S. Patent US20190116741A1 aims to increase penetration of substances across leaf surface and subsequent transport into the phloem, in which a group of researchers from UF introduced a CO₂ laser, creating indentations of approximately 250 μm in diameter. The method described in this patent is based in perforations to enhance the foliar intake of substances.

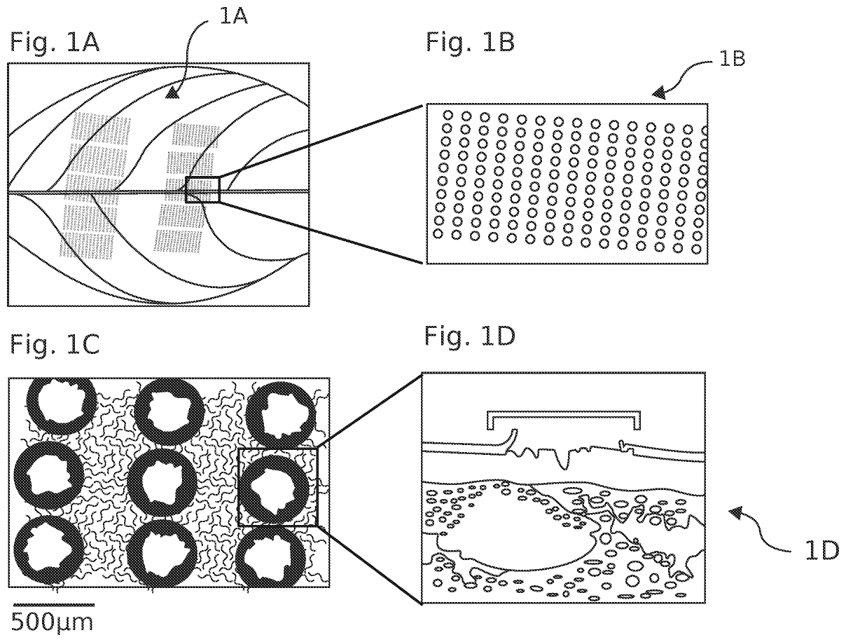

In FIG. 1, the invention provides a general prior art on micro-perforations as patented comprises an approach the laser perforates the cuticle. Here, the citrus leaf lasered to create perforations 1A, close-up of a single rectangle laser perforation pattern in 1A showing the cuticle perforations 1B, high magnification scanning electron micrograph of a laser-perforated leaf surface 1C and high magnification of perforated leaf surface 1D. Each perforation across the cuticle had a diameter of 300-500 μm. A pattern consisting of 150 perforations per rectangle and the total exposed area per pulse is only 0.000019 cm². Each perforation across the cuticle had a diameter of 300-500 μm. A pattern consisting of 150 perforations per rectangle. The total exposed area per pulse is only 0.000019 cm².

The second U.S. prior art Patent Application No. 202000037607 The disclosure provides a method of delivering a substance to a plant, the method comprising (a) exfoliating a region of epicuticular wax on a plant surface. The laser energy is applied using an erbium-doped yttrium aluminum garnet (Er: YAG) laser. The method is good, does not damage the leave. The main inconvenient is the high price of laser. In addition, the laser process implies an increase in temperature that can damage the epidermis.

Now turning to the invention, the present invention describes materials and methods for delivering substances to plants. The invention discloses a method to enhance substances uptake by plants using selective ablation of light pulses to remove the wax cuticle on a large scale in fields. The invention provides a method designed to improve the capture of agrochemicals through the leaves of plants, which works by removing the wax cuticle to allow access of the substances.

The invention works based on the selectivity of the action of monochromatic pulses, whose wavelength is in the green colour range. Due to its wavelength, the pulsed light is absorbed only by the wax cuticle and instead it is reflected by the epidermis without affecting it. Once the wax cuticle has been removed, the chemical substance can be applied, which will easily penetrate the interior of the plant.

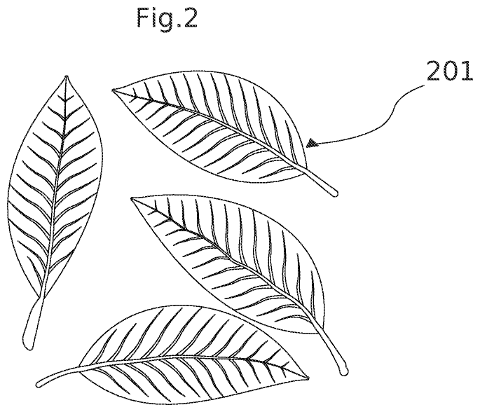

In FIG. 2, the invention shows fresh citrus leaves 200 illustrating the cuticles 201. For example, the citrus leaves have a high reflection and low absorption, while the wax cuticle have a high absorption. It has a good selectivity, which means that wax cuticle will be selectively ablated while the epidermis will be preserved without damages.

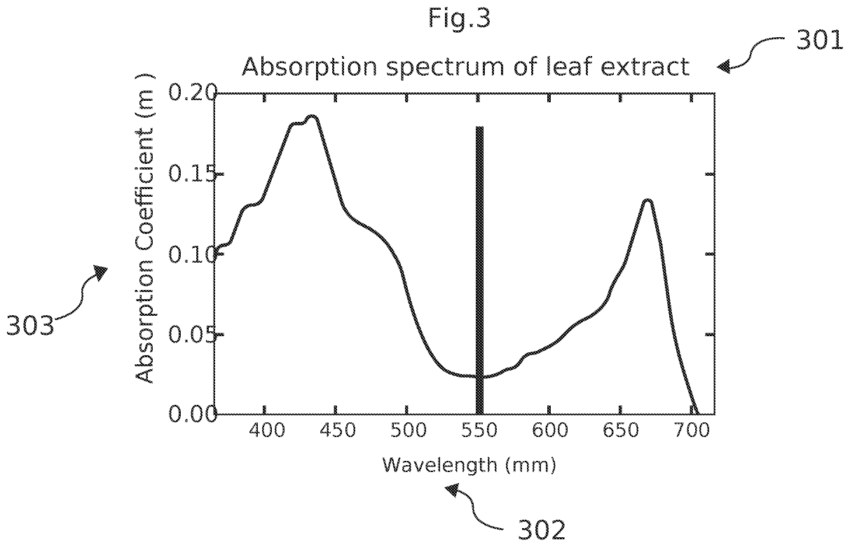

According to FIG. 3, the said invention provides a step of selective ablation by laser using wavelength in the green range of spectrum 300. It describes an absorption spectrum of leaf extract 301, comprising a wavelength range of between 350 and 700 nm and an absorption coefficient of 0.02 and 0.2 m⁻¹ 302. The implications of laser selectivity further comprise a minimal damage to cuticle and leaf structure, high removal of wax rate. For example, for the second harmonic of Nd laser (532 nm). In addition as discussed above in FIG. 2, the citrus leaves 200 have a high reflection and low absorption, while the wax cuticle have a high absorption. It has a good selectivity, which means that wax cuticle will be selectively ablated while the epidermis will be preserved without damages.

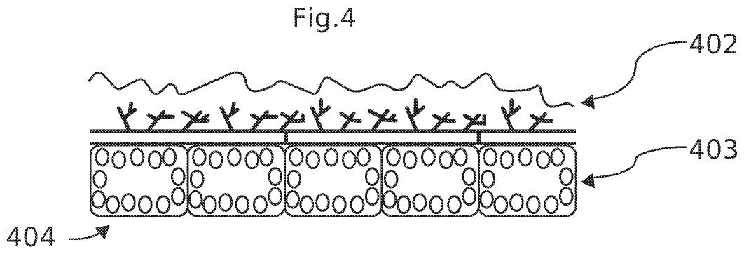

In FIG. 4, the invention avails a prior to laser ablation 400 state of the leave 200 illustrating dew 401 covering the epicuticular wax 402, epidermis 403 covering the inner tissues 404 further comprising inner cells 406 and the air space between the tissues presented as stomata 405.

Still on FIG. 4, the invention presents a laser using green wavelength 407 showing penetrating the due 401 and epicuticular wax 402 to the epidermal layer 403.

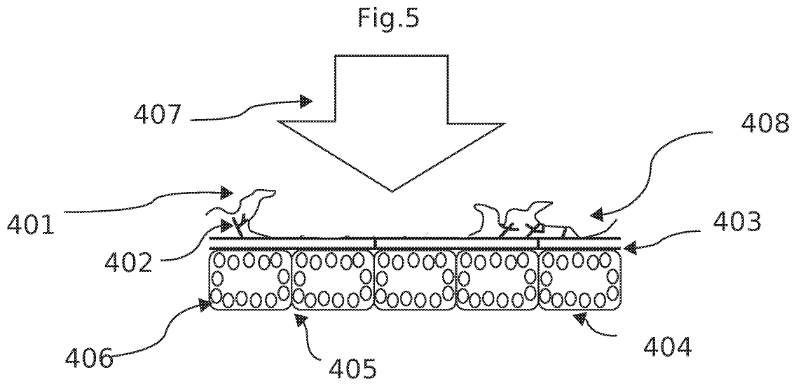

FIG. 5 shows a therapeutic compound 501 application and penetration through cuticle-exfoliated areas 502 and successfully enabling the compound 501 to reach the epidermal layer 404. Immediate effect of laser impacting the leaf surface 401 and generating accessibility for therapeutic compounds 501 through wax cuticle exfoliation 402. Therapeutic compound 501 application and penetration through cuticle-exfoliated areas 402, successfully reaching the inner epidermal layer 404.

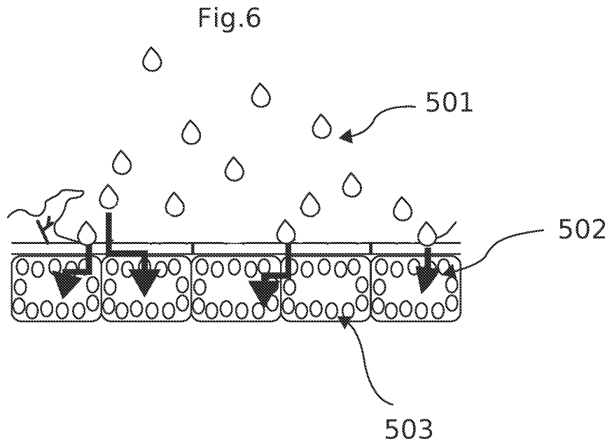

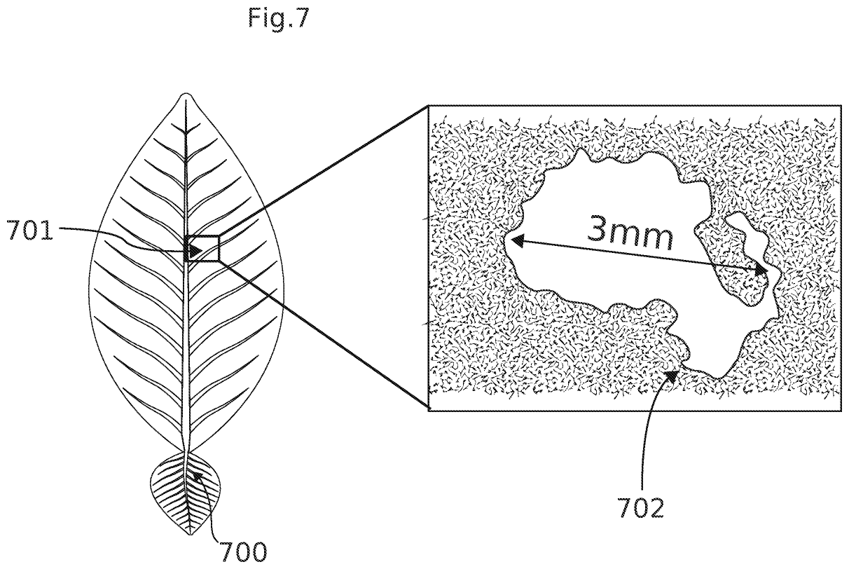

In FIG. 6, the invention shows area where the laser 407 removed the wax 402 and expose the epidermis 403. Within the treated area 601, the laser removes the wax 402 but does not affect the epidermis 403. A large area 602 from mm to cm in diameter with a single laser shot! There is no perforation or thermal damage! It shows Nd: YAG laser, wavelength: 532 nm, pulse duration: 20 ns burst mode and repetition rate: 1-10 Hz.

Some advantages are noted here. The leaves epidermis looks green due to chlorophyll 503 reflectance for that wavelength as shown in FIG. 5. The wax absorbs this wavelength, but the epidermis reflects it. Laser pulses 532 nm wavelength should be used for selective wax removal. Short duration process (nanosecond range) minimizing thermal impact. It does not need to be focused with a lens. Easy to implement for field conditions. Compact, portable laser. Low cost.

The present invention is not limited to the embodiments described above. Various changes and modifications can, of course, be made, without departing from the scope and spirit of the present invention. Additional advantages and modifications will readily occur to those skilled in the art. Accordingly, various modifications may be made without departing from the spirit or scope of the general inventive concept as defined by the appended claims and their equivalents.

It will also be appreciated that such development effort might be complex and time-consuming, but would nevertheless be a routine undertaking for those of ordinary skill in the field of the appropriate art having the benefit of this disclosure. Accordingly, the Claims appended hereto are not intended to be limited by the disclosed embodiments, but are to be accorded their widest scope consistent with the principles and features disclosed herein.

To the accomplishment of the above and related objects, this invention may be embodied in the form illustrated in the accompanying drawings, attention being called to the fact, however, that the drawings are illustrative only and that changes may be made in the specific construction illustrated and described within the scope of the appended claims.

### INDUSTRIAL APPLICATION

The present invention applies to generally, relates to materials and methods for delivering substances to plants and in particular method to enhance substances uptake by plants using selective ablation of light pulses to remove the wax cuticle on a large scale in fields. The leaves epidermis looks green due to chlorophyll reflectance for the spectral range between 495 nm and 570 nm. The wax partially absorbs this wavelength, but the epidermis reflects it. Laser pulses within such spectral range should be used for selective wax removal. Short duration process (nanosecond range) minimizing thermal impact. It does not need to be focused with a lens. Easy to implement for field conditions. Compact, portable laser. Low cost.

What is claimed is:

1. A method to enhance substances uptake by plants using selective ablation of light pulses to remove the wax cuticle, comprising steps of:
a. using selective ablation of light pulses;
b. removing the wax cuticle, and
c. using lasers.

2. The method according to claim 1, wherein the method further comprise laser selective ablation of wax based on optical properties of leaves.

3. The method according to claim 1, wherein the method further comprises selectively removing the wax and facilitating the entry of any agrochemical.

4. The method according to claim 1, wherein the method further comprises the use of lasers, pulsed lamps or other light sources like solar filtered solar light to remove the wax selectively without damage the leaves.

5. The method according to claim 1, wherein the selective ablation of light pulses is being used to enhance substances uptake by plants.

6. The method according to claim 1, wherein the removing the wax cuticle is performed by using selective ablation of light pulses on a large scale in fields.

7. The method according to claim 1, wherein the lasers, pulsed lamps or other light sources like solar filtered solar light are being used for selective ablation of wax based optical properties of leaves to remove the wax selectively without damage the leaves.

8. The method according to claim 1, wherein the method further comprises steps of:
a. enhancing substances uptake by plants using selective ablation of light pulses to remove the wax cuticle on a large scale in fields;
b. improving the capture of agrochemicals through the leaves of plants by removing the wax cuticle to allow access of the substances;
c. selective ablation by laser using wavelength.

9. The method according to claim 8, wherein the step (c) is based on the selectivity of the action of monochromatic pulses, whose wavelength is in the green colour range, wherein due to its wavelength, the pulsed light is absorbed only by the wax cuticle and instead it is reflected by the epidermis without affecting it.

10. The method according to claim 9, wherein once the wax cuticle has been removed, the chemical substance is applied, which can easily penetrate the interior of the plant.

11. The method according to claim 10, wherein the preferred plant is fresh citrus leaves due to their:
a. high reflection rate;
b. low absorption rate;
c. high absorption rate of the wax cuticle;
d. good selectivity of the wax cuticle enabling them to be suitable for selectively ablated; and
e. having the capacity to preserve the epidermis without damages.

12. The method according to claim 11, wherein the at the step of selective ablation by laser using wavelength in the green range of spectrum 495 nm to 570 nm.

13. The method according to claim 12, wherein the absorption spectrum of leaf extract further comprises:
a. a wavelength ranges of between 350 and 700 nm; and
b. an absorption coefficient of 0.02 and 0.2 m−1.

14. The method according to claim 13, wherein the laser selectivity further comprises a minimal damage to cuticle and leaf structure and high removal of wax rate, further comprising for the second harmonic of Nd laser of wavelength 532 nm.

15. The method according to claim 13, wherein the laser selectivity further comprises a minimal damage to cuticle and leaf structure and high removal of wax rate, further comprising for the second harmonic of Nd laser of any wavelength in the range 495-570 nm.

16. A method for delivering substances to plants, comprising steps of:
a. applying a laser ablation using green wavelength of 532 nm to penetrate epicuticular wax to the epidermal layer;
b. applying laser ablation to enable a therapeutic compound application and penetration through cuticle-exfoliated areas; and
c. successfully enabling the therapeutic compound to reach the epidermal layer.

17. The method according to claim 16, wherein:
a. the immediate effect of laser is to impact the leaf surface and generate accessibility for therapeutic compounds through wax cuticle selective ablation;
b. at the step of impacting the leaf surface the area where the laser removed the wax also expose the epidermis;
c. within the treated area, the laser is enabled to remove the wax without affecting the epidermis;
d. the said treated area can be large ranging from mm to cm in diameter with a single laser shot;
e. there is no perforation or thermal damage to the leaf, and further comprising a laser wavelength of about 532 nm, pulse duration of about 1 fs to 100 ns, and repetition rate of about 1-100,000 Hz, and
f. material for enhancing substances uptake by plants using selective ablation of light pulses to remove the wax cuticle, comprising selective ablation of light pulses of a wavelength of about 532 nm or within the range 495 to 570 nm.

18. The material according to claim 17, wherein the said materials are designed for:
delivering substances to plants;
removing the wax cuticle on a large scale in fields;
improving the capture of agrochemicals through the leaves of plants, which works by removing the wax cuticle to allow access of the substances.

19. The material according to claim 18, wherein the material for selective ablation of light pulses using laser pulses of 532 nm wavelength or within the range 495 to 570 nm for selective wax removal, wherein the laser,
further comprises short duration process (nanosecond range) minimizing thermal impact;
does not need to be focused with a lens;
is easy to implement for field conditions, and
is compact, portable laser and of low cost.
